(19) United States
(12) Patent Application Publication
(10) Pub. No.: US 2010/0062327 A1
(43) Pub. Date: Mar. 11, 2010

(54) NON-TOXIC ALKALINE ELECTROLYTE WITH ADDITIVES FOR RECHARGEABLE ZINC CELLS

(76) Inventor: Lin-Feng Li, Croton-on-Hudson, NY (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/207,334

(22) Filed: Sep. 9, 2008

(51) Int. Cl. H01M 6/04

(52) U.S. Cl. 429/105

(57) ABSTRACT

An electrolyte composition for zinc-based electrochemical cells that contains KOH and potassium acetate (KAcet) and/or soluble salts of cesium. The electrolyte significantly eliminates shape change and dendrite growth while retaining high ionic conductivity. Anticorrosion compounds such as soluble indium compounds may be included alone or in combination with auxiliary anticorrosion compounds such as soluble tin compounds to improve charged stand and shelf life. Optionally, lithium hydroxide may be added to the electrolyte to facilitate charge acceptance of the positive electrode, particularly at cold temperatures.

### CROSS-REFERENCE TO RELATED APPLICATIONS

This application relates to a non-provisional U.S. Patent Appl. entitled “Rechargeable Zinc Cell with Longitudinally-folded Separator” by inventors Lin-Feng Li, Fuyuan Ma, and Zhenghao Wang and to a non-provisional U.S. Patent Appl. entitled “Polymer Membrane Utilized as a Separator in Rechargeable Zinc Cells” by inventor Lin-Feng Li, both filed concurrently, which applications are incorporated herein in their entirety by reference.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to alkaline electrolyte electrochemical cells, and more specifically to an electrolyte for cells having zinc electrode, wherein the electrolyte comprises non-toxic additives to improve the cycling characteristics of the cells by inhibiting shape change of the zinc electrode and zinc dendrite growth while maintaining high power capability.

2. Description of Related Art

Increasingly strict environmental regulations, surging oil prices, the proliferation of the Internet and electronic devices have given rise to new growing markets for portable and stationary battery power, such as for use with hybrid vehicles, electric vehicles, renewable energy storage systems, UPS systems for data centers, and so on. With the increasing availability of Hybrid Electric Vehicles (HEV), Plug-in Hybrid Electric Vehicles (PHEV) and Electric Vehicles (EV), there is a genuine demand for the high performance batteries that can meet future challenges. Such batteries require high power, high energy, more reliability and safety, longer life, low cost and must be environmentally benign.

Various battery chemistries have been explored as higher energy density alternatives to replace conventional lead acid and nickel cadmium batteries. These old incumbent battery technologies cannot keep up with increasing energy requirements for the new applications, and they pose environmental difficulties due to their use of toxic metal components that are difficult to dispose with safety.

Zinc has long been recognized as the ideal electrode material, due to its high specific capacity (813 Ah/kg), low electrochemical overpotential (namely, higher cell voltage), high coulombic efficiency, reversible electrochemical behavior, high rate capability, high abundance in the early crust (and therefore low material cost), and its environmental friendliness. Therefore, rechargeable zinc cells containing zinc electrodes, such as, for exemplary purposes only, nickel/zinc, silver/zinc, manganese dioxide/zinc and zinc/air cells, have generated significant interest. Compared to nickel/cadmium cells, the nickel/zinc cell has an open cell voltage over 1.72 V vs. 1.4 V for nickel cadmium cell. Further, huge environmental issues have been found in recent years for both manufacturing and disposing toxic nickel/cadmium cells. Therefore, there is a strong market need for developing high power, long cycle life and environmental friendly rechargeable batteries with zinc as the anode material.

Despite their advantages, conventional rechargeable zinc-based cells suffer short cycle life, believed to be caused by three major factors: Shape change of the zinc electrode, zinc dendrite shorting through the separator to the positive electrode and the zinc electrode shedding material during cycling.

As is well known, utilizing conventional electrolytes, such as potassium hydroxide and/or lithium hydroxide, the zinc species, i.e., zincate (Zn(OH)₄²) formed during discharge and remaining when the cell is in a discharged condition, is soluble in the electrolyte to a large extent. Upon recharging, zinc metal is re-deposited on the electrode surface but at different locations. The active zinc material tends to migrate from the edge to the center of the electrode in process known as densification called “shape change” which typically results in an irreversible loss of capacity for the electrode, particularly when the cell is discharged at high rate.

As is also known, recharging of zinc cells often leads to formation of tree or needle-shaped zinc metal crystals, called dendrites, which often puncture through the separator layer between the zinc electrode and the positive electrode, causing a short circuit between the two electrodes, leading eventually to failure of the cells.

In addition, repeated swelling and contracting of the zinc electrode during cycling coupled with mossy zinc deposition when the cell is charged at low current densities, can also lead to zinc electrode material loss—so called “shedding”, wherein loose zinc electrode material falls from contact with the electrode, often accumulating in the bottom of the cell container resulting in irretrievably lost cell capacity.

The fundamental reason of zinc electrode shape change has not been well established. Numerous mechanisms were proposed to offer explanation, including 1) electrolyte flow caused by electro-osmotic pressure in cells with ion exchange membrane; 2) natural convection caused by gravity effect; 3) zinc local dissolution and deposition caused by local potential difference at different sites; 4) electrolyte concentration difference due to non-uniform current distribution; 5) direct oxidation of zinc at the edge by the oxygen transferred from the counter electrode.

In actual cells, multiple factors might contribute. However, it seems that electrolyte plays an important role, particularly, the solubility of zinc oxide in the potassium hydroxide electrolyte. The propensity of formation of saturated or super saturated zincate solution is strongly associated with the shape change process, and, to some degree, all other processes that shorten the life of zinc-containing cells.

Numerous attempts have been made in the field in order to control the electrode shape change and shedding, and to reduce the dendrite growth, including, without limitation, use of calcium hydroxide in the zinc electrode to form insoluble calcium zincate (CaZn₂(OH)₆), as demonstrated by E. G. Gagnon, in J. Electrochem. Soc., vol. 133, pp. 1989 (1986). However, power and energy density of the electrode are significantly compromised.

It has also been previously proposed to add selected salts to the potassium hydroxide (KOH) electrolyte which to allow use of lower concentration KOH while maintaining high ionic conductivity. Combinations of KOH, potassium fluoride (KF), potassium carbonate (K₂CO₃) and/or potassium borate (K₃BO₃) have been demonstrated in nickel/zinc cell as taught in U.S. Pat. No. 3,485,673 to Jost et al., U.S. Pat. No. 4,247,610 to Thornton and U.S. Pat. No. 5,302,475 to Adler et al. Although over 500 cycles have been demonstrated in laboratory cells with much better uniformity of zinc electrode, the toxic and corrosive nature of KF poses severe environmental issues for disposal of the battery. Also, due to a large quantity of K₂CO₃ which has reduced ionic conductivity, the cell has poor power capability and lower electrode utilization. Accordingly, the addition of such salts is disadvantageous since power capability is essential for high power applications, such as EV, HEV and power tool applications.

Other approaches have utilized electrolytes with minimal hydroxyl content, containing phosphate. For example, Eisenberg (U.S. Pat. No. 4,224,391; U.S. Pat. No. 5,215,836) has developed a series of mixed electrolytes containing 3M KOH and 3 M K₃PO₄, wherein the presence of potassium phosphate reduces the zincate solubility.

A number of other electrolyte additives have also been proposed, including silicates (Flerov (1955) and Marshall and Hampson (1974)), ferro- or ferricyanides (Julian), borates (Eisenberg) and arsenates (Eisenberg). These suffer similar problems as for carbonate and/or fluoride additions to the electrolyte.

In a recent publication, Doddapaneni and Ingersoll (U.S. Pat. No. 5,378,550) suggested use of 1,3,5-phenyltrisulfonic acid in combination with KOH as the electrolyte for rechargeable Ni/Zn cells. Only a limited number of cycles was achieved, and the charge efficiency was rather low (<50%).

Addition of lead or tin ions to the electrolyte has long been utilized as a method of influencing zinc deposition (F. Mansfield, S. Gilman, J. Electrochem. Soc., 117, pp. 588, 1970; ibid 117, pp. 1154, 1970). The beneficial effect was attributed to blocking of active sites, leading to a smooth, rounded deposit. Nonetheless, shape change of the electrode and thus reduction of the cycle life of the cell was not significantly improved (J. McBreen, E. Gagnon, J. Electrochem. Soc., Vol. 130, pp. 1980, 1983.).

Organic electrolyte additives, particularly quaternary ammonium compounds, have been reported to influence the zinc deposit morphology (Ruetschi, P.; U.S. Pat. No. 3,160,520). However, long term stability of those additives is not good due to Hoffman elimination reaction in alkaline electrolyte.

Further, the material utilized for the cell separator should comprise a membrane with the ability to resist dendrite penetration while allowing electrolyte permeation. Still further, the material employed should be chemically stable in the cell environment. Additionally, a suitable membrane should be sufficiently flexible and mechanically strong enough to withstand stress during repeated cycling.

Therefore, it is readily apparent that there is a need for a new alkaline electrolyte can reduce zinc electrode shape change, prevent the shedding of electrode and eliminate the growth of zinc dendrites, while still maintaining the high power capability and environmental friendliness of the zinc electrode.

### BRIEF SUMMARY OF THE INVENTION

Briefly described, in a preferred embodiment, the present invention overcomes the above-mentioned disadvantages and meets the recognized need for such a composition by providing an electrolyte for zinc-based electrochemical cells, such as, for exemplary purposes only, nickel-zinc cells, silver-zinc cell, manganese dioxide (MnO₂)-zinc cells, active carbon-zinc cells, and zinc-air cells, wherein the electrolyte contains KOH, and potassium acetate (KAcet) and/or soluble salts of cesium, and wherein the electrolyte significantly eliminates shape change and dendrite growth while retaining high ionic conductivity. Optionally, lithium hydroxide may be added to the electrolyte to facilitate charge acceptance of the positive electrode of the electrochemical cell, particularly at cold temperatures. The zinc electrodes may be manufactured by combining a powdered mixture of the desired materials, typically zinc metal and zinc oxide, and a binder that is rolled onto a suitable current collector, such as, for exemplary purposes only, a copper screen.

According to its major aspects and broadly stated, the present invention in its preferred form is an electrolyte for a rechargeable cell having a zinc electrode, wherein the electrolyte contains potassium hydroxide (KOH) in a concentration of from approximately 1% to approximately 55%, and wherein the electrolyte comprises a soluble cesium salt, such as, for exemplary purposes only, cesium carbonate (CsCO₃), cesium fluoride (CsF), cesium acetate (CsCH₃CO₂—hereinafter “CsAcet”, cesium citrate (Cs₃C₆H₅O₇.2H₂O), and/or CsX, in a concentration of approximately 1% to approximately 50%, and wherein the electrolyte comprises an acetate, such as, for exemplary purposes only, CsAcet and/or (KC₂H₃O₂—hereinafter “KAcet”) in a concentration range of from approximately 0.1% to approximately 50%.

The electrolyte could further comprise an anticorrosion additive, such as for exemplary purposes only, a soluble indium compound. The indium compound could comprise, for exemplary purposes only indium sulfate (In₂(SO₄)₃), indium acetate (InAcet), and/or indium nitrate (In₃(NO₃)₂) .

The electrolyte could also comprise an auxiliary anticorrosion additive, such as, for exemplary purposes only, a soluble tin compound. The soluble tin compound could comprise, for exemplary purposes only, potassium stannate (K₂Sn(OH) 6), sodium stannate (Na₂Sn(OH) 6), cesium stannate (Cs₂Sn(OH)₆), and/or tin acetate (SnAcet).

The electrolyte could further include a soluble salt of bismuth to promote formation of a conductive network and/or to facilitate charging and discharging of the zinc electrode, and/or lithium hydroxide (LiOH) in a concentration from approximately 0.1% to approximately 30% to facilitate charge acceptance of the positive electrode, particularly at low temperatures.

In a preferred method of improving the performance of zinc-based electrochemical cells an electrochemical cell comprising a zinc-based negative electrode, a positive electrode and a separator is obtained; an electrolyte comprising KOH and at least one cesium salt is added to the electrochemical cell; if improved performance of the positive electrode is desired, lithium hydroxide (LiOH) is optionally added to the electrolyte in a concentration from approximately 0.1% to approximately 30%; and the electrochemical cell is charged and discharged.

Additionally, an anticorrosion additive and/or an auxiliary anticorrosion additive may be added to the electrolyte to improve charged stand and/or shelf life.

More specifically, the present invention is, in one example, a nickel-zinc cell having an electrolyte comprising 20% KOH, 1% LiOH, 5% KAcet, 5% CsCO₃ and 150 ppm In₂(SO₄)₃. The results were that the cell has much increased cycle life and storage life over conventional 30% KOH and 1% LiOH electrolyte. In another example, the nickel-zinc cell has an electrolyte comprising 20% KOH, 1% LiOH, 8% CsAcet and 200 ppm In₂(SO₄)₃. The results were that the cell has improved charge-discharge cycling than conventional 30% KOH and 1% LiOH electrolyte.

In a third example, the nickel-zinc cell has an electrolyte comprising 20% KOH, 1% LiOH, 5% KAcet, 5% CsCO₃, 150 ppm In₂(SO₄)₃ and 150 ppm K₂SnO₃. The results were that the cell has much longer cycle life and storage life than conventional 30% KOH and 1% LiOH electrolyte. In last example, the nickel-zinc cell has an electrolyte comprising 10% KOH, 1% LiOH, 15% CsAcet and 150 ppm In₂(SO₄)₃. The results were that the cell has much longer cycle life and storage life than conventional 30% KOH and 1% LiOH electrolyte.

Lithium hydroxide is utilized only for improved low temperature charge acceptance of the positive electrode of the cell. It will be recognized by those skilled in the art that sodium hydroxide (NaOH) could be utilized in place of, or in combination with, potassium hydroxide (KOH).

Accordingly, a feature and advantage of the present invention is its ability to reduce shape change.

Another feature and advantage of the present invention is its ability to suppress and/or reduce dendrite growth.

Still another feature and advantage of the present invention is its ability to reduce solubility of zincate.

Yet another feature and advantage of the present invention is that it provides high ionic conductivity.

Yet still another feature and advantage of the present invention is improved capacity upon standing in the charged condition.

A further feature and advantage of the present invention is its improved shelf life.

These and other features and advantages of the present invention will become more apparent to one skilled in the art from the following description and claims.

### DETAILED DESCRIPTION OF THE PREFERRED AND SELECTED ALTERNATE EMBODIMENTS OF THE INVENTION

In describing the preferred and selected alternate embodiments of the present invention, specific terminology is employed for the sake of clarity. The invention, however, is not intended to be limited to the specific terminology so selected, and it is to be understood that each specific element includes all technical equivalents that operate in a similar manner to accomplish similar functions.

A preferred embodiment comprises KOH, soluble salts of cesium, and/or potassium acetate (KAcet). The electrolyte may optionally contain LiOH in order to improve the charge acceptance of the counter electrode, for exemplary purposes only, a nickel hydroxide electrode.

The composition of the preferred embodiment substantially reduces the solubility of zincate (Zn(OH)₄²⁻), wherein shape change and dendrite growth problems are substantially eliminated. Zincate solubility is dependent upon the concentration of KOH present in the electrolyte and is proportional thereto. Consequently, by reducing the concentration of KOH in the electrolyte of the preferred embodiment, solubility of zincate is reduced, thereby reducing the dissolution of zincate that upon conversion back to zinc would result in dendrites or shape change of the zinc electrode. Concurrently, the electrolyte offsets the reduction of KOH concentration and retains high ionic conductivity that enables favorable charging and discharging performance for both cathode and anode.

From empirical results, ZnO has been found to have much lower solubility in solutions containing cesium compounds than in the corresponding KOH solution. Accordingly, a mixture of KOH and/or cesium salt, e.g., without limitation, Cs₂CO₃ and CsAcet, reduces the solubility of ZnO and substantially eliminates the shape change issues associated with zinc-based cells.

Increasing the concentration of KOH in an alkaline electrolyte-based cell has the advantage of increasing ionic conductivity. However, zincate is increasingly soluble in KOH electrolytes as the concentration increases, thereby removing active material from the zinc electrode and providing increased activity for shape change and dendrite growth. In an ideal situation, zincate would not be soluble in the electrolyte, and thus would remain in place within the structure of the negative electrode, wherein charging and discharging would not result in redistribution of zinc in the form of a densified electrode or in dendritic growth.

Fortunately, KAcet may be added to the electrolyte. KAcet is non-toxic with substantial solubility in water, wherein the Ac⁻ anion does not interfere with the cathodic and anodic reactions. Addition of KAcet in KOH electrolyte improves ionic conductivity of the electrolyte while permitting maintenance of the KOH concentration at a low level to suppress zincate solubility.

In one preferred embodiment, an electrolyte is provided for a battery having zinc or zinc alloy as an active anode and a metal oxide or metal hydroxide, such as, for exemplary purposes only, nickel hydroxide, as an active cathode material. The electrolyte is formed by mixing KOH with Cs₂CO₃ cesium halides (CsX) and/or KAcet.

Optionally, the electrolyte could also comprise soluble salts of indium, bismuth and/or tin. These compounds in the electrolyte help maintain the stability of the anode, reduce corrosion and extend the shelf life of the battery cell.

There are two preferred ways to prepare the new electrolyte. One is to create it in situ by reacting excess KOH or CsOH with weak acids including acetic acid, such as, for exemplary purposes only, carbonic acid. The other is to add certain amount of salt to KOH electrolyte.

Electrolytes with favorable characteristics have been prepared utilizing the above-mentioned compositions as follows:

### Example I

### All Percentages are Weight Percent

In a nickel-zinc cell, 20% KOH, 1% LiOH, 5% KAcet, 5% CsCO₃, 150 ppm In₂(SO₄)₃ were combined to form the electrolyte. The results were that the cell has much increased cycle life and storage life over conventional 30% KOH and 1% LiOH electrolyte. In order to demonstrate the effectiveness of this electrolyte, nickel-zinc cells with conventional nickel electrodes, zinc electrodes and non-woven separator FS2225 from Freudenberg were fabricated. It is worthy to note that non-woven separator is not known to be able to block dendrite growth. A conventional cell with conventional electrolyte yields only 15 cycles, while the cells with the electrolyte of Example I delivered over 160 cycles.

### Example II

### All Percentages are Weight Percent

In a nickel-zinc cell, 20% KOH, 1% LiOH, 8% CsAcet, 200 ppm In₂(SO₄)₃ were combined to form the electrolyte. The results were that the cell has improved charge-discharge cycling than conventional 30% KOH and 1% LiOH electrolyte. Cells fabricated according to Example II delivered 210 cycles.

### Example III

### All Percentages are Weight Percent

In a nickel-zinc cell, 20% KOH, 1% LiOH, 5% KAcet, 5% CsCO₃, 150 ppm In₂(SO₄)₃ and 150 ppm K₂SnO₃ were combined to form the electrolyte. The results were that the cell has much longer cycle life and storage life than conventional 30% KOH and 1% LiOH electrolyte. 155 cycles was achieved for cells with the electrolyte of Example III.

### Example IV

### All Percentages are Weight Percent

In a nickel-zinc cell, 10% KOH, 1% LiOH, 15% CsAcet, 150 ppm In₂(SO₄)₃ were combined to form the electrolyte. The results were that the cell has much longer cycle life and storage life than conventional 30% KOH and 1% LiOH electrolyte. 320 cycles was achieved for cells with the electrolyte of Example IV.

In alternate embodiments, LiOH may not be included in the electrolyte, wherein improved low temperature charge acceptance of the positive electrode of the cell is not required.

In another alternate embodiment, bismuth salts could be included in the electrolyte.

In still another alternate embodiment, sodium hydroxide (NaOH) could be utilized in place of, or in combination with, potassium hydroxide (KOH).

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. An electrolyte for a rechargeable cell having a zinc electrode, said electrolyte comprising:
KOH, wherein the range of concentration of KOH is from approximately 1% to approximately 55%; and
a soluble cesium salt.

2. The electrolyte of claim 1, wherein said soluble cesium salt is selected from the group consisting of CsCO₃, CsF, CsAcet, cesium citrate, CsX, and combinations thereof.

3. The electrolyte of claim 1, further comprising acetate.

4. The electrolyte of claim 3, wherein said acetate is selected from the group consisting of CsAcet, KAcet, and combinations thereof.

5. The electrolyte of claim 4, wherein the range of concentration of acetate in the electrolyte is from approximately 0.1% to approximately 50%.

6. The electrolyte of claim 1, wherein said soluble cesium salt is present in a concentration of approximately 1% to approximately 50%.

7. The electrolyte of claim 1, further comprising at least one soluble salt selected from the group consisting of indium, bismuth and tin.

8. The electrolyte of claim 1, further comprising an anticorrosion additive.

9. The electrolyte of claim 8, wherein said anticorrosion additive comprises a soluble indium compound.

10. The electrolyte of claim 9, wherein said soluble indium compound is selected from the group consisting of indium sulfate, indium acetate, indium nitrate, and combinations thereof.

11. The electrolyte of claim 1, further comprising an auxiliary anticorrosion additive.

12. The electrolyte of claim 11, wherein said auxiliary anticorrosion additive comprises a soluble tin compound.

13. The electrolyte of claim 12, wherein said soluble tin compound is selected from the group consisting of potassium stannate, sodium stannate, cesium stannate, tin acetate, and combinations thereof.

14. The electrolyte of claim 1, further comprising LiOH.

15. The electrolyte of claim 14, wherein the range of concentration of LiOH in the electrolyte is from approximately 0.1% to approximately 30%.

16. A method of improving the performance of zinc-based electrochemical cells, said method comprising the steps of:
obtaining an electrochemical cell comprising a zinc-based negative electrode, a positive electrode and a separator;
adding an electrolyte to said electrochemical cell, wherein said electrolyte comprises KOH and at least one cesium salt;
optionally, adding LiOH to said electrolyte in a concentration from approximately 0.1% to approximately 30%; and
charging and discharging said electrochemical cell.

17. The method of claim 16, further comprising the step of:
adding an anticorrosion additive to said electrolyte.

18. The method of claim 17, further comprising the step of:
adding an auxiliary anticorrosion additive to said electrolyte.

19. An electrolyte for zinc-based electrochemical cells, said electrolyte comprising:
KAcet from approximately 0.1% to approximately 50%.

20. The electrolyte of claim 19, further comprising a soluble cesium salt.
